(19) United States
(12) Patent Application Publication
(10) Pub. No.: US 2017/0133971 A1
(43) Pub. Date: May 11, 2017

(54) OVERVOLTAGE PROTECTION SELF-TRIGGER CIRCUIT FOR DOUBLE FED INDUCTION GENERATOR (DFIG) WIND POWER SYSTEM

(71) Applicant: GE Energy Power Conversion Technology Ltd, Rugby, Warwickshire (GB)

(72) Inventors: Jincheng HUANG, ShangHai (CN); Jie DING, ShangHai (CN); Chengjun WANG, ShangHai (CN); Jun ZHU, ShangHai (CN)

(73) Assignee: GE Energy Power Conversion Technology Ltd, Ruby, Warwickshire (GB)

(21) Appl. No.: 15/322,807

(22) PCT Filed: Jul. 2, 2014
(86) PCT No.: PCT/CN2014/081458

§ 371 Date: Dec. 29, 2016

(51) Int. Cl. H02P 29/024; H02P 9/00; F03D 9/25

(52) U.S. Cl. CPC H02P 29/0241; F03D 9/255; H02P 9/007; F05B 2220/706

(57) ABSTRACT

Provided is an overvoltage protection device for protecting a wind turbine against overvoltage. The device includes a double fed induction generator (DFIG) including a rotor connection including a plurality of electrical connections coupled to rotor leads of the DFIG and a stator connection including a plurality of electrical connections coupled to stator leads of the DFIG. Also included is a self-triggering circuit coupled with the rotor connection and operative in response to changes in a utility grid voltage during a grid fault when an overvoltage event is detected such that the overvoltage protection circuit automatically operates, independently of a controller or a sensor, to reduce the detected overvoltage to a predetermined voltage level.

### I. FIELD OF THE INVENTION

The present disclosure relates generally to the field of double fed induction generators. In particular, the present disclosure relates to control and protection of double fed induction generators during grid faults.

### II. BACKGROUND OF THE INVENTION

In recent years, as the supply of our fossil energy resources, such as oil and coal, decreases and the prices and the effort to recover them increase, alternative energy resources, for example, such as wind energy produced by wind turbines, have become popular for supplying the increasing demand for electric power. Wind turbines are one type of renewable energy-based power unit that competes with traditional forms of electric power generation. As a result, wind turbines capture wind energy and convert it to electrical energy in a cost effective, reliable and safe manner such that it is suitable for delivery miles away.

In operation, the wind turbines may include multiple rotating blades that are connected to a rotor shaft and rotated by the wind. The rotation of the blades by the wind spins the rotor shaft to generate a rotational torque or force that drives one or more generators to convert mechanical energy to electrical energy. The rotor shaft and generator are mounted within a housing or nacelle that is positioned on top of a truss or tubular tower. The electrical energy generated in the nacelle is distributed down through the tower to a utility grid via a transformer.

Wind energy has several applications, ranging from large fields of wind turbines, interconnected and delivering power to the utility grid, to individual, isolated wind turbines that may or may not be grid-connected. As such, wind turbines can be used to produce electricity for a single home or building, or they can be connected to an electricity grid for more widespread electricity distribution. The interconnection of the wind turbines to the electrical grid can be grouped into classifications based on the size of the installations, the size of the contribution to a total electricity supply (wind penetration), whether the electricity is used for frequency or reactive power, and the degree of integration with other power sources.

One classification is wind farms, which consist of large fields of co-located wind turbines that are interconnected to a utility grid and act in concert with a conventional utility plant. The fields can consist of hundreds of machines that generate hundreds of megawatts of electricity. Large wind farms connected to the grid typically interconnect at the transmission level of the electric grid. Typically, in a wind farm, the individual wind turbines are interconnected with a medium voltage power collection system and communications network. At a substation, this medium-voltage electrical current is increased in voltage with a transformer for connection to the high voltage electric power transmission system.

Another classification is distributed wind generation system (also referred to as “distributed power systems” (DPS), “distributed generator systems” (gensets) and “distributed generators”), which are smaller-scale wind turbines that generate electricity located near its point of use. These distributed systems can either be connected to the electric grid or operate independently.

The distributed systems connected to the grid are usually joined at the distribution level of the grid. They may be integrated into the electric utility grid so that the utility may be relied on for back-up power such that a part of the electricity is used locally and the remainder is delivered to the grid. However, in most cases, these small turbines are used primarily for generating electricity for use on-site, rather than transmitting energy over the electric grid. Small wind turbines have less generating capacity than large wind farms. They normally generate from less than a kilowatt to tens of megawatts of electricity.

Wind turbines connected to the grid are frequently subjected to grid faults. Various grid faults can occur in the electrical networks and most of them are related with the network voltage. They are usually characterized by a change in the magnitude of the voltage and by time duration. Wind turbines may employ various protection systems in order to ensure their proper operation during fault conditions such as over-speed, overvoltage and under voltage protection.

Traditionally, the protection system of wind turbines was designed to disconnect the wind turbine unit whenever a grid fault was detected. Until recently, wind turbines connected to the grid were small-sized installations connected at the distribution levels and the total amount of wind power generation capacity installed was small in proportion to the total amount of installed generation capacity. As a result, there was previously little need for such installations to meet a defined set of grid connection and technical performance requirements. Thus, in the past, there was no requirement by the grid code for a wind turbine to remain connected to the grid during a fault or a voltage disturbance.

However,the influx of large wind farms connecting to the existing electric power grid has increased over the years and, has led to the large-scale use of wind power within the power system. This integration into the existing electric power grid has raised many questions and brought a number of technical challenges to grid stability because wind power is an intermittent energy source, which must be used, in most cases, when available. With wind turbines not only becoming larger but also being put into groups as large wind farms, in some cases, wind farms can provide the electrical grid with a significant part of the total energy production within a certain geographical area.

Thus, the level of penetration of wind energy into the power system has increased to such an extent that the connection of large wind turbines to the grid has a large impact on grid stability, reliability, security, and power quality. Wind energy “penetration” refers to the fraction of energy produced by wind compared with the total available generation capacity in the power system.

This variability can present substantial challenges to incorporating large amounts of wind power into a grid system. As a result, the increasing penetration of wind energy into the power systems of many regions and countries has therefore led to revisions to the grid code that define requirements for the connection of wind farms to electrical networks. Namely, these grid code requirements typically refer to large wind farms, connected to the transmission level of the grid, rather than smaller stations connected at the distribution level. Such requirements are known as Fault Ride Through (FRT) or Low Voltage Ride Through (LVRT).

The Fault Ride Through (FRT) or Low Voltage Ride Through (LVRT) is the most important requirement regarding wind farm operation that has been recently introduced in the grid codes. The new grid codes require wind farms to remain connected and support the grid during and after a fault. The Fault Ride Through requirements were established in response to the large increase in wind capability that feeds into transmission systems, making it necessary for wind generation to stay operational in the event of a network fault.

The specific grid connection requirements vary in different parts of the world. However, generally, the new requirements demand that wind power plants and wind farms that connect at the transmission level behave more like conventional power plants. Hence, they have to take over many of the control tasks that hold the power system stable. Wind power plants are groups of turbines that share common infrastructure such as electrical interconnection facilities and service roads. Wind plants can range in size from a few megawatts to hundreds of megawatts in capacity.

In the past, during grid disturbances and low grid voltages, the wind turbines and wind farms were allowed to disconnect from the grid. But nowadays, all new grid codes stipulate that wind turbines and wind farms operating at the transmission level should contribute to the power system control, both frequency and voltage control, in a similar manner as a conventional power station. These requirements are vital for a stable and reliable operation of power supply networks, especially in regions with high penetration of wind power generation.

In such regional connections, if there is a large amount of electricity being generated by wind and produced in the network, the simultaneous disconnection of wind generating units and wind farms can generate a fault in the grid, which can cause larger voltage depression across wide regions, a lost of some generation units, and eventually a collapse of voltage in the affected region. Furthermore, the additional loss of power generation as a result of the disconnection can cause a greater imbalance and thus drop in the system frequency in the wider region.

For grid systems that integrate wind turbines, a common conventional practice used to enhance the transient stability of the grid system is to interconnect variable speed wind turbines using double-fed induction generators (DFIGs),instead of fixed-speed wind turbines, into the system. DFIGs generally have more desirable properties for grid integration. Typically, DFIGs are used in variable speed generation (VSG) systems for generating electric energy from intermittent or variable energy resources such as wind farms.

A primary advantage of variable speed generation systems over fixed speed systems is the possibility of electronically controlling the shaft speed in order to maintain maximum efficiency of the energy conversion process. Variable-speed wind turbines can harvest much more energy compared to fixed-speed wind turbines because depending on the wind speed, they can operate at the optimum rotational speed at which the aerodynamic efficiency of the wind rotor is maximum. Thus, the DFIG technology has proven to be an efficient and cost-effective solution for variable speed wind turbines. The DFIGs are currently the most widely used type of electrical generators for wind turbine systems in the Megawatt range.

A basic configuration of a DFIG used in a wide range of application because of their efficiency and reliability is shown in FIG. 1. FIG. 1 illustrates a wind turbine 10 coupled to a utility grid 12 for electrical power distribution and includes a wind turbine 14 coupled to a DFIG 18. The DFIG 18 includes a DFIG generator 19 comprising a rotor 16 and a stator 20.

The rotor 16 provides rotor windings 22 for transfer of AC power between the rotor 16 and a back-to-back DFIG converter 24. The stator 20 has stator windings 26 coupled to the grid 12. The converter 24 is a back-to-back structure comprising a rotor side converter (RSC) circuit 28, a DC intermediate circuit 30 providing a DC bus (DB) with a capacitance C, and a line side converter circuit 32. The line side converter (LSC) circuit 32 is coupled between the stator windings 26 and the DC intermediate circuit 30.

As mentioned above, wind turbines connected to the grid are frequently subjected to grid faults and overvoltages during the grid fault. Unfortunately, an important disadvantage of the DFIG wind turbine is that the DFIG generator is quite sensitive to grid faults and requires special power converter protection. Before the introduction of the Fault Ride Through requirements in the grid codes, wind farms equipped with DFIG wind turbines were allowed to disconnect from the grid in the case of significant grid disturbances. However, according to the new grid codes, wind farms are required to remain connected to and support the grid during and after a fault.

In order to protect the sensitive components of the wind turbine and mitigate the effects of severe grid faults on the DFIG, a cost-effective solution is to employ a DFIG with a crowbar circuit, as shown in FIG. 1. A crowbar circuit 34 is coupled between the rotor 16 and the RSC 28. The crowbar circuit 34 consists of a full-wave bridge rectifier, a power resistor, and an isolated gate bipolar transistor (IGBT) switch. To protect the RSC 28 from tripping due to overcurrents in the rotor circuit or overvoltage in the DC-link during grid voltage dips, the crowbar circuit 34 is connected to the rotor windings 22 of the DFIG 18.

During normal operation the crowbar circuit 34 is open. Initially during a grid fault, a sensor (not shown) detects the overvoltage. Then, a controller (not shown) triggers the crowbar circuit 34 or implements a control strategy to lower the overvoltage to protect the DFIG wind power system. The circuit 34 can be activated on detection of rotor 16 overcurrents or DC-link overvoltage in order to redirect the rotor currents in the crowbar circuit 34, where the energy is dissipated in the resistor such that the high current peaks are successfully redirected away from the RSC 28 to protect the rotor 16 and back-to-back converter 24 components from excessive voltage spikes. Traditional crowbar circuits, as shown in FIG. 1, are constructed with resistors to consume power or eliminate the overvoltage. Therefore, both the crowbar circuit and the DB need the controller to be triggered in order to properly operate.

Thus, when a grid fault occurs, DFIG wind turbines enhanced with a traditional crowbar circuit and a dedicated control circuit, are capable of meeting all the Fault Ride Through requirements as stipulated in the recent grid codes. The crowbar circuit can also provide protection for the sensitive components of DFIGs and Fault Ride Through compliance can be achieved. However if the crowbar and/or controller malfunctions or is inoperable during a fault, the DFIG and the other system components will be unprotected and may suffer permanent damage.

The sensors and controllers that monitor and control the crowbar circuit 34 are very sensitive to overvoltage such that sometimes they are destroyed or may fail during an overvoltage event. If there is a malfunction in the sensor or controller, the traditional crowbar circuit cannot be triggered and the DFIG wind power systems will be unprotected by the crowbar circuit during the overvoltage. As a result of the overvoltage, components, such as the converter DC-link, IGBT blast and/or other components, in the DFIG wind power system may be permanently damaged due to the controller and/or sensor failure.

### III. SUMMARY OF THE INVENTION

Given the aforementioned deficiencies, a need exists for a self-triggering circuit that absorbs overvoltage energy to provide protection to the DFIG wind power system. A need also exists for a self-triggering circuit that ensures the safety of the DFIG system even when the sensors and/or controllers are malfunctioning or destroyed during the grid fault. It may also be desirable to provide a crowbar circuit that is self-triggering such that it works independently without needing the assistance of a controller.

Under certain circumstances, an overvoltage protection device is provided for protecting a wind turbine against overvoltage. The device includes a DFIG including a rotor connection including a plurality of electrical connections coupled to rotor leads of the DFIG and a stator connection including a plurality of electrical connections coupled to stator leads of the DFIG. Also included is a self-triggering circuit coupled with the rotor connection and operative in response to changes in a utility grid voltage during a grid fault when an overvoltage event is detected such that the overvoltage protection circuit automatically operates, independently of a controller or a sensor, to reduce the detected overvoltage to a predetermined voltage level.

Further features and advantages, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### IV. BRIEF DESCRIPTION OF THE DRAWINGS

FIG. 1 is a block diagram of a basic configuration of a DFIG wind power system;

FIG. 2 is a schematic and block diagram of an example of a DFIG wind power system comprising a single-phase self-triggering circuit in accordance with the present disclosure;

FIG. 3 is a schematic and block diagram of an example of a DFIG wind power system comprising a three-phase self-triggering circuit in accordance with the present disclosure; and

FIG. 4 is a flowchart of an exemplary method of practicing the present invention in accordance with the present disclosure.

The present disclosure may take form in various components and arrangements of components, and in various process operations and arrangements of process operations. The present disclosure is illustrated in the accompanying drawings, throughout which, like reference numerals may indicate corresponding or similar parts in the various figures. The drawings are only for purposes of illustrating preferred embodiments and are not to be construed as limiting the disclosure. Given the following enabling description of the drawings, the novel aspects of the present disclosure should become evident to a person of ordinary skill in the art.

### V. DETAILED DESCRIPTION OF VARIOUS EMBODIMENTS

The following detailed description is merely exemplary in nature and is not intended to limit the applications and uses disclosed herein. Further, there is no intention to be bound by any theory presented in the preceding background or summary or the following detailed description. While embodiments of the present technology are described herein primarily in connection with DFIG wind power systems, the concepts are also applicable to other types of wind turbine system having a converter such as full power converter wind power systems or other similar systems with a converter.

The embodiments described herein include a wind turbine system that provides protection against overvoltage. More, specifically, an overvoltage protection device is provided as a self-triggering circuit which may be used for protecting the wind turbine with respect to overvoltage events. It is thus possible to provide a voltage level in a range which is not harmful for electrical and/or auxiliary wind turbine components even though overvoltage may be present at the electrical utility grid to which the wind turbine is connected.

As used herein, the term “overvoltage” is intended to be representative of a voltage level which exceeds a predetermined voltage level such as a reference voltage level. This reference voltage level may be set according to maximum voltage level which may be applied at electrical and/or auxiliary components of the wind turbine. As used herein, the term “blade” is intended to be representative of any device that provides a reactive force when in motion relative to a surrounding fluid.

As used herein, the term “wind turbine” is intended to be representative of any device that generates rotational energy from wind energy, and more specifically, converts kinetic energy of wind into mechanical energy. As used herein, the term “wind generator” is intended to be representative of any wind turbine that generates electrical power from rotational energy generated from wind energy, and more specifically, converts mechanical energy converted from kinetic energy of wind to electrical power.

In various embodiments, the present disclosure provides a self-triggering circuit that absorbs overvoltage energy to provide protection to the DFIG wind power system. The self-triggering circuit ensures the safety of the DFIG system even when the sensors and/or controllers are malfunctioning or destroyed during a grid fault. Various embodiments provide a crowbar circuit or a short circuit that is self-triggering such that it works independently without needing the assistance of a controller. Thus, the self-trigger crowbar or short circuit does not require any additional control circuit to perform its functions. Thus, it saves on hardware cost and controlling cost. The self-triggering circuit enables the DFIG to become more robust during grid faults, which saves on maintenance cost.

In various embodiments, the self-triggering circuit comprises a single phase self-triggering circuit. In other embodiments, the self-triggering circuit comprises a three-phase self-triggering circuit.

An exemplary embodiment of a DFIG wind power system 200 with a single-phase self-trigger circuit 202, which is coupled to a utility grid 204 for electrical power distribution. The DFIG wind power system 200 includes a wind turbine 206 coupled to a DFIG 208. The DFIG 208 includes a DFIG generator 210 comprising a rotor 212 and a stator 214. The system 200 includes a gearbox 216 operatively coupled to the wind turbine 206 and the DFIG generator 210.

The rotor windings of the DFIG 208 are coupled to a back-to-back converter 220 via a protection self-triggering circuit 202,and the stator windings of the DFIG 208 are coupled to the utility grid 204. The converter 220 is a back-to-back structure comprising a RSC circuit 224, a DC intermediate circuit 226 providing a DB with a capacitance C, and an LSC 228. The LSC circuit 228 is coupled between the stator windings of the DFIG 208 and the DC intermediate circuit 226.

In various embodiments, the wind turbine system 200 may include an electrical and control system (not shown) comprising a turbine controller (not shown). The turbine controller may include at least one processor and a memory, at least one processor input channel, at least one processor output channel, and may include at least one computer. As used herein, the term computer is not limited to integrated circuits referred to in the art as a computer, but broadly refers to a processor, a microcontroller, a microcomputer, a programmable logic controller (PLC), an application specific integrated circuit, and other programmable circuits, and these terms are used interchangeably herein.

In the exemplary embodiment, memory may include, but is not limited to, a computer-readable medium, such as a random access memory (RAM). Alternatively, one or more storage devices, such as a floppy disk, a compact disc read only memory (CD-ROM), a magneto-optical disk (MOD), and/or a digital versatile disc (DVD) may also be used. Also, in the exemplary embodiment, additional input channels may be, but are not limited to, computer peripherals associated with an operator interface such as a mouse and a keyboard. Further, in the exemplary embodiment, additional output channels may include, but are not limited to, an operator interface monitor.

Processors for turbine controller process information transmitted from a plurality of electrical and electronic devices that may include, but are not limited to, voltage and current transducers. RAM and/or storage devices store and transfer information and instructions to be executed by the processor. RAM and/or storage devices can also be used to store and provide temporary variables, static (i.e., non-changing) information and instructions, or other intermediate information to the processors during execution of instructions by the processors. Instructions that are executed include, but are not limited to, resident conversion and/or comparator algorithms. The execution of sequences of instructions is not limited to any specific combination of hardware circuitry and software instructions.

In various embodiments, the turbine controller (not shown) is configured to receive a plurality of voltage and electric current measurement signals from one or more voltage and electric current sensors. Moreover, the turbine controller is configured to monitor and control at least some of the operational variables associated with wind turbine 200. The voltage and electric current sensors are electrically coupled to any portion of electrical and control system that facilitates operation of electrical and control system.

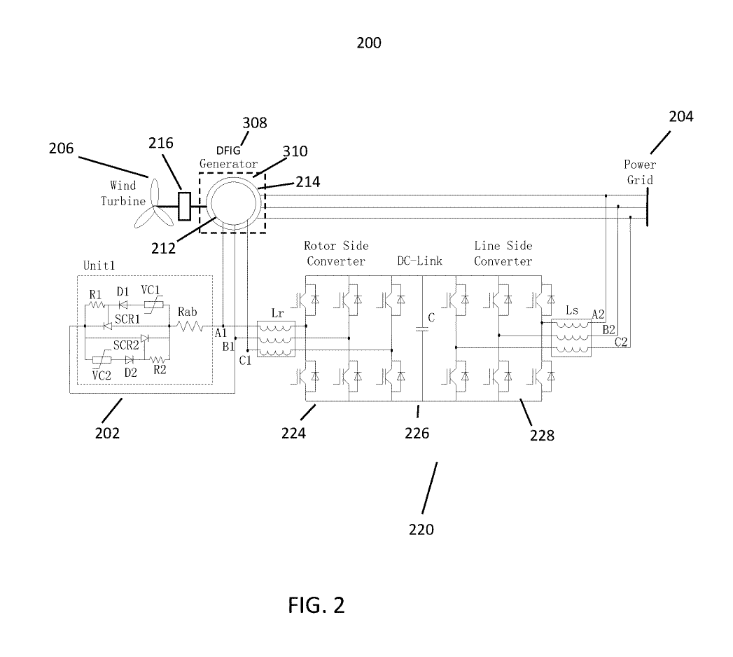

In the event the sensors and/or controllers are malfunctioning or destroyed during a grid fault event, as shown in FIG. 2, the wind turbine system 200 includes a protection self-triggering circuit 202 configured to be triggered by itself such that it automatically turns on to provide a short circuit or a crowbar circuit to thus absorb overvoltage energy to provide protection to the DFIG wind power system and thus prevent damage to the components.

The protection self-triggering circuit 202 does not require activation by the sensor and/or controller. Thus, should the sensor and/or controller malfunction during a grid fault, the protection self-triggering circuit 202 will remain operable and continue to function to provide a short circuit or crowbar path. The protection self-triggering circuit 202 operates independently without needing the assistance or activation of a controller. Thus, the self-triggering crowbar does not require any additional control circuit to perform its functions.

In various embodiments, the protection self-triggering circuit 202 is composed of resistors R1, R2, diodes D1, D2, thyristors SCR1, SCR2, arrestors VC1, VC2 and resistor Rab. In the exemplary embodiment shown in FIG. 2, only one protection self-triggering circuit 202 is shown. However, three protection self-triggering circuits 202 would normally be included within the DFIG wind power system 200, but have been omitted from FIG. 2 for clarity.

In various embodiments, the protection self-triggering circuit 202 is provided between the rotor 212 and the rotor side 224 of the back-to-back converter 220 at connection points A1, B1, and C1 for protecting the DFIG during fault conditions. In an alternative arrangement, the protection self-triggering circuit 202 may also be provided between the line side 228 of the back-to-back converter 220 at connection points A2, B2, and C2 based on the overvoltage protection requirement. However, in FIG. 2, for clarity sake, only one phase self-triggering circuit 202 is shown connected at points A1 and B1 on the rotor side converter 224.

In the event of an overvoltage event during a grid fault, if the overvoltage occurs between points A1 and B1, the voltage potential at point A1 is higher than the voltage potential at point B1, and the overvoltage exceeds the threshold of the arrestor VC1, the current through VC1 will trigger the thyristor SCR1. Resistor Rab will absorb the energy of the overvoltage and prevent the overvoltage from destroying the rotor side converter 224, DC intermediate circuit 226, and the line side converter 228. On the other hand, if the voltage potential at point B1 is higher than the voltage potential at point A1 during the grid fault, and the overvoltage exceeds the threshold of the arrestor VC2, the current through VC2 will trigger the thyristor SCR2.

Resistor Rab will absorb the energy of the overvoltage and prevent the overvoltage from destroying the rotor side converter 224, DC intermediate circuit 226, and the line side converter 228. In various embodiments according to the present teachings, diodes D1, D2 and resistors R1, R2 can be used to protect thyristors SCR1 and SCR2 gate pole at their reverse voltage periods. Arrestors VC1 and VC2 can be a metal oxide arrestor (MOA) or other voltage clamping devices.

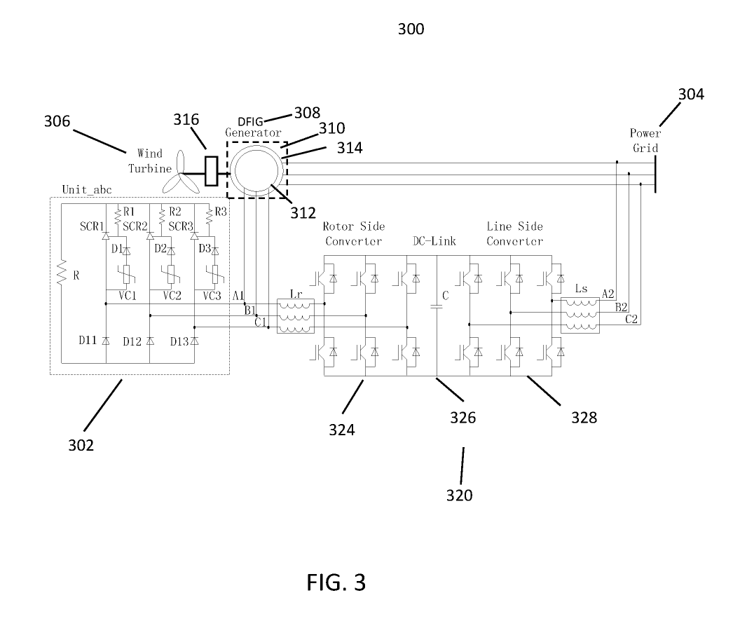

In an alternative embodiment, an exemplary embodiment of a DFIG wind power system 300 with a three-phase self-trigger circuit 302, which is coupled to a utility grid 304 for electrical power distribution, is shown in FIG. 3. The DFIG wind power system 300 includes a wind turbine 306 coupled to a DFIG 308. The DFIG 308 includes a DFIG generator 310 comprising a rotor 312 and a stator 314. The system 300 includes a gearbox 316 operatively coupled to the wind turbine 306 and the DFIG generator 310.

The rotor windings of the DFIG 308 are coupled to a back-to-back converter 320 via a protection self-triggering circuit 302, and the stator windings of the DFIG 308 are coupled to the utility grid 304. The converter 320 is a back-to-back structure comprising a RSC circuit 324, a DC intermediate circuit 326 providing a DB with a capacitance C, and a LSC 328. The LSC circuit 328 is coupled between the stator windings of the DFIG 308 and the DC intermediate circuit 326.

In various embodiments, the wind turbine system 300 may include an electrical and control system (not shown) comprising a turbine controller (not shown). The turbine controller may include at least one processor and a memory, at least one processor input channel, at least one processor output channel, and may include at least one computer.

As used herein, the term computer is not limited to integrated circuits referred to in the art as a computer, but broadly refers to a processor, a microcontroller, a microcomputer, a programmable logic controller (PLC), an application specific integrated circuit, and other programmable circuits, and these terms are used interchangeably herein. In the exemplary embodiment, memory may include, but is not limited to, a computer-readable medium, such as a RAM.

Alternatively, one or more storage devices, such as a floppy disk, a CD-ROM, a MOD, and/or a DVD may also be used. Also, in the exemplary embodiment, additional input channels may be, but are not limited to, computer peripherals associated with an operator interface such as a mouse and a keyboard. Further, in the exemplary embodiment, additional output channels may include, but are not limited to, an operator interface monitor.

Processors for turbine controller process information transmitted from a plurality of electrical and electronic devices that may include, but are not limited to, voltage and current transducers. RAM and/or storage devices store and transfer information and instructions to be executed by the processor. RAM and/or storage devices can also be used to store and provide temporary variables, static (i.e., non-changing) information and instructions, or other intermediate information to the processors during execution of instructions by the processors. Instructions that are executed include, but are not limited to, resident conversion and/or comparator algorithms. The execution of sequences of instructions is not limited to any specific combination of hardware circuitry and software instructions.

In various embodiments, the turbine controller (not shown) is configured to receive a plurality of voltage and electric current measurement signals from one or more voltage and electric current sensors. Moreover, the turbine controller is configured to monitor and control at least some of the operational variables associated with wind turbine 300. The voltage and electric current sensors are electrically coupled to any portion of electrical and control system that facilitates operation of electrical and control system.

In the event the sensors and/or controllers are malfunctioning or destroyed during a grid fault event, as shown in FIG. 3, the wind turbine system 300 includes a protection self-triggering circuit 302 configured to be triggered by itself such that it automatically turns on to provide a short circuit or a crowbar circuit to thus absorb overvoltage energy to provide protection to the DFIG wind power system and thus prevent damage to the components. The protection self-triggering circuit 302 does not require activation by the sensor and/or controller.

Thus, should the sensor and/or controller malfunction during a grid fault, the protection self-triggering circuit 302 will remain operable and continue to function to provide a short circuit or crowbar path. The protection self-triggering circuit 302 operates independently without needing the assistance or activation of a controller. Thus, the self-triggering crowbar does not require any additional control circuit to perform its functions.

In various embodiments, the protection self-triggering circuit 302 is composed of resistors R1, R2, R3, diodes D11, D12, D13, thyristors SCR1, SCR2, SCR3, and arrestors VC1, VC2, VC3. In order to simplify the configuration of FIG. 2, which requires three self-triggering circuits 222, as described above, the exemplary embodiment shown in FIG. 3 discloses a three-phase self-triggering circuit 302. In various embodiments, the protection self-triggering circuit 302 is provided between the rotor 312 and the rotor side 324 of the back-to-back converter 20 at connection points A1, B1, and C1 for protecting the DFIG during fault conditions, as shown in FIG. 3.

In an alternative arrangement, the protection self-triggering circuit 302 may also be provided between the line side 328 of the back-to-back converter 320 at connection points A2, B2, and C2 based on the overvoltage protection requirement. However, in FIG. 3, for clarity sake, the three-phase self-triggering circuit 302 is shown connected at points A1, B1, and C1 on the rotor side converter 324.

In the event of an overvoltage event during a grid fault, if the overvoltage occurs between points A1 and B1, the voltage potential at point A1 is higher than the voltage potential at point B1, and the overvoltage exceeds the threshold of the arrestor VC1, the current through VC1 will trigger the thyristor SCR1. As a result, the thyristor SCR1 and diode D12 becomes self-triggering to limit the overvoltage and prevent the overvoltage from destroying the rotor side converter 324, DC-Link 326, and the line side converter 328.

On the other hand, if the voltage potential at point B1 is higher than the voltage potential at point A1 during the grid fault, and the overvoltage exceeds the threshold of the arrestor VC2, the current through VC2 will trigger the thyristor SCR2. Consequently, the thyristor SCR2 and diode D11 will become self-triggering to limit the overvoltage and prevent the overvoltage from destroying the rotor side converter 324, DC-Link 326, and the line side converter 328.

In various embodiments according to the present teachings, diodes D1, D2, D3 and resistors R1, R2, R3 can be used to protect thyristors SCR1, SCR2, and SCR3 gate pole at their reverse voltage periods. Arrestors VC1, VC2, and VC3 can be a metal oxide arrestor (MOA) or other voltage clamping devices.

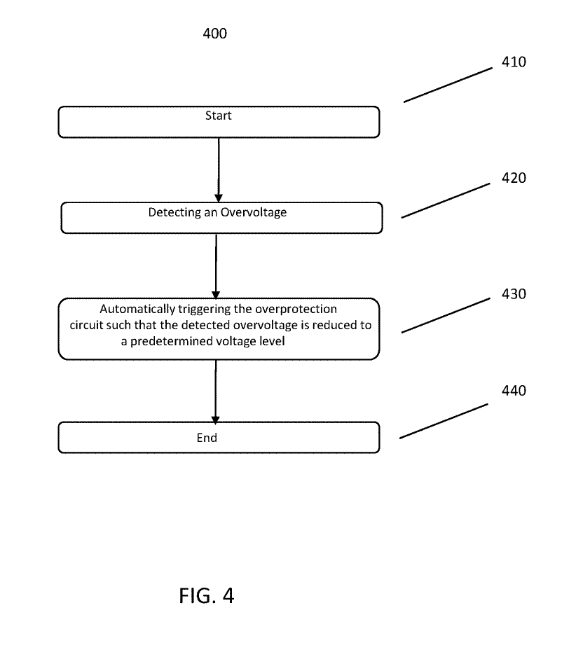

FIG. 4 is a flowchart illustrating of an exemplary method 400 for protecting a wind turbine against overvoltage. At block 410, the procedure is started. Then, electrical power is generated by a DFIG wind turbine generator. If an overvoltage is detected at block 420, the overprotection circuit is automatically triggered, without the assistance of a controller and/or sensor, such that the detected overvoltage is reduced to a predetermined voltage level in block 430. The procedure is ended at block 440.

The above-described devices and methods facilitate an overvoltage protection of wind turbine components. In particular, the installation of power generation utilities at grid networks may be provided which are exposed to high voltage. It is thus possible to keep a voltage which is applied at electrical and/or auxiliary components within a wind turbine, within a certain range, where the electrical and/or auxiliary components can operate without damaging them. This may lead to a continuous normal operation without damaging components that are connected to the mains and/or the electrical utility grid.

It will be apparent to those skilled in the art that various modifications and variations can be made to the overvoltage protection device and method of the present disclosure without departing from the scope of its teachings. By way of example, overvoltage protection devices in accordance with the present teachings may be used with full power converter wind power systems, plural-phase wind power systems or other similar systems comprising a converter.

Alternative embodiments, examples, and modifications which would still be encompassed by the disclosure may be made by those skilled in the art, particularly in light of the foregoing teachings. Further, it should be understood that the terminology used to describe the disclosure is intended to be in the nature of words of description rather than of limitation.

Those skilled in the art will also appreciate that various adaptations and modifications of the preferred and alternative embodiments described above can be configured without departing from the scope and spirit of the disclosure. Therefore, it is to be understood that, within the scope of the appended claims, the disclosure may be practiced other than as specifically described herein.

### PARTS LIST 265541

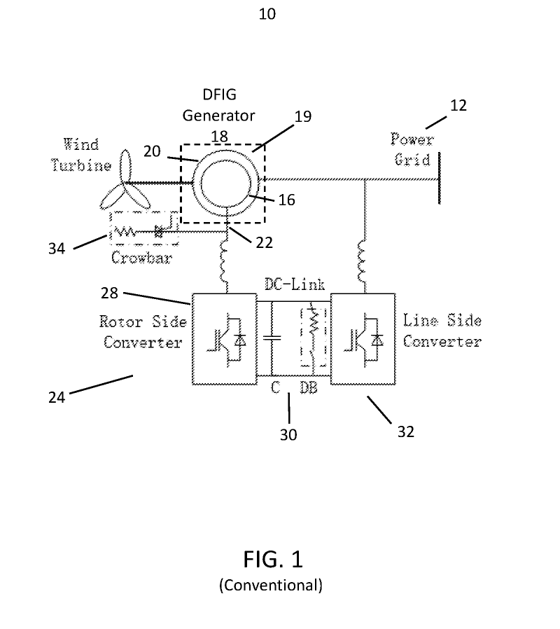

FIG. 1
10—wind turbine
12—grid
16—rotor
18—DFIG
19—generator
20—stator
22—rotor windings
24—converter
30—intermediate circuit
32—converter circuit
34—crowbar circuit
FIG. 2
200—wind power system
202—circuit
204—utility grid
206—windturbine
212—rotor
214—stator
216—gearbox
220—converter
224—rotor side converter (RSC) circuit
226—DCintermediate circuit
228—line side converter (LSC) circuit, line side
308—DFIG
310—DFIG generator
FIG. 3
300—wind power system, wind turbine system
302—self-triggering circuit
304—utility grid
306—wind turbine
308—DFIG
310—DFIG generator
312—rotor
314—stator
316—gearbox
320—converter
324—rotor side converter (RSC) circuit
326—DC intermediate circuit
328—line side converter circuit (LSC
FIG. 4
400—method
410—block
420—block
430—block
440—block

We claim:

1. An overvoltage protection device comprising for protecting a wind turbine against overvoltage, the device comprising:
a double fed induction generator (DFIG) including a rotor connection including a plurality of electrical connections coupled to rotor leads of the DFIG and a stator connection including a plurality of electrical connections coupled to stator leads of the DFIG; and
a self-triggering circuit coupled with the rotor connection and operative in response to changes in a utility grid voltage during a grid fault when an overvoltage event is detected such that the overvoltage protection circuit automatically operates, independently of a controller or a sensor, to reduce the detected overvoltage to a predetermined voltage level.

2. The overvoltage protection circuit of claim 1, wherein the self-triggering circuit is configured to automatically operate when the utility grid voltage exceeds a threshold value.

3. The overvoltage protection device of claim 1, wherein the self-triggering circuit comprises resistors, diodes, thyristors, and arrestors.

4. The overvoltage protection circuit of claim 3, wherein the self-triggering circuit is configured to automatically operate when the utility grid voltage exceeds a predetermined threshold value of at least one arrestor.

5. The overvoltage protection circuit of claim 4, wherein when the utility grid voltage exceeds the predetermined threshold value of the at least one arrestor, the current flowing through the at least one arrestor triggers at least one thyristor to operate such that the resistors will absorb the energy of the overvoltage to protect components of the DFIG wind turbine system.

6. The overvoltage protection device of claim 1, wherein the self-triggering circuit comprises a crowbar circuit.

7. The overvoltage protection device of claim 1, wherein the self-triggering circuit comprises a short circuit.

8. The overvoltage protection device of claim 1, wherein the self-triggering circuit comprises a single-phase self-triggering circuit.

9. The overvoltage protection device of claim 1, wherein the self-triggering circuit comprises a three-phase self-triggering circuit.

10. A method for protecting a wind turbine against overvoltage without activation by a controller or sensor, the method comprising:
providing a double fed induction generator (DFIG) including a rotor connection including a plurality of electrical connections coupled to rotor leads of the DFIG and a stator connection including a plurality of electrical connections coupled to stator leads of the DFIG;
monitoring a change in a utility grid voltage; and
automatically operating a self-triggering circuit, independently of a controller or a sensor, in response to changes in the utility grid voltage during a grid fault when an overvoltage event is detected.

11. The method of claim 10, wherein the self-triggering circuit is configured to automatically operate when the utility grid voltage exceeds a threshold value.

12. The method of claim 10, wherein the self-triggering circuit comprises resistors, diodes, thyristors, and arrestors.

13. The method of claim 12, wherein the self-triggering circuit is configured to automatically operate when the utility grid voltage exceeds a predetermined threshold value of at least one arrestor.

14. The method of claim 13, wherein, when the utility grid voltage exceeds the predetermined threshold value of the at least one arrestor, the current flowing through the at least one arrestor triggers at least one thyristor to operate such that the resistors will absorb the energy of the overvoltage to protect components of the DFIG wind turbine system.

15. The method of claim 10, wherein the self-triggering circuit comprises a crowbar circuit.

16. The method of claim 10, wherein the self-triggering circuit comprises a short circuit.

17. The method of claim 10, wherein the self-triggering circuit comprises a single-phase self-triggering circuit.

18. The method of claim 10, wherein the self-triggering circuit comprises a three-phase self-triggering circuit.
